(19) United States
(12) Patent Application Publication
(10) Pub. No.: US 2016/0092834 A1
(43) Pub. Date: Mar. 31, 2016

(54) CLOSED-LOOP CONTAINER INDENTIFICATION AND TRACKING METHOD AND APPARATUS

(71) Applicant: Schaefer Systems International, Inc., Charlotte, NC (US)

(72) Inventors: David R. McCulloch, Lexington, KY (US); Chad T. Jenkins, Charlotte, NC (US)

(21) Appl. No.: 14/870,809

(22) Filed: Sep. 30, 2015

Related U.S. Application Data
(60) Provisional application No. 62/057,331, filed on Sep. 30, 2014.

(51) Int. Cl. G06Q 10/08; G06K 7/10

(52) U.S. Cl. CPC G06Q 10/087; G06K 7/10366; G06Q 10/0833

(57) ABSTRACT

A closed-loop box identification and tracking system that includes a plurality of boxes for being moved by at least one box transport apparatus between an origination point and a destination point, each box containing an RFID tag. At least one RFID reader/transmitter is provided to interact with the at least one box transport apparatus, and is adapted to read the RFID tags when in proximity to the RFID reader/transmitter and transmit the identification of the RFID tag. An RFID receiver and associated digital computer is provided for receiving, storing and processing the transmitted RFID identification for determining the location of the boxes from the processed RFID identification.

### TECHNICAL FIELD AND BACKGROUND OF THE INVENTION

This invention relates to a closed-loop container identification and tracking method and apparatus. In particular, the invention is directed to the efficient and accurate identification and tracking of individual returnable, reusable container systems, such as parts containers, variously referred to as “boxes”, “ packages”, “totes”, “cartons” , “lids”, “bulk bins”, “racks”, “pallets”, “top caps” and the like, often containing dunnage that permits parts to be securely positioned for shipment and storage until use. Such containers are often used to contain and protect parts, components or subassemblies used for installation during an assembly line sequence in manufacturing facilities. As used in this application the term “box” is used to refer to this type of container, as distinct from large “steel” cargo containers of the type carried aboard container ships, and later delivered by tractor trailer trucks, rail or air. Such containers are often used to transport boxes that are used on assembly lines in manufacturing facilities. The “users” may be assembly line manufacturing facilities or other businesses that find it necessary or desirable to use reusable boxes to ship and store and deploy for use parts or supplies.

In a typical manufacturing system, thousands of parts boxes flow in a closed loop between parts suppliers and the manufacturing facility, where the boxes of parts may arrive just-in-time from a parts supplier, are placed for ready access by assembly line workers, and are emptied as parts are retrieved from the boxes and installed on equipment being assembled. When empty, the boxes are shipped back to a supplier to be refilled and shipped back to a manufacturing facility.

Because these boxes must be reused to maintain a steady supply of parts, it is important to know at any given time where the boxes are so that they can be routed efficiently to either the assembly line or a supplier location. The ability to determine the location of such boxes is also useful in preventing or identifying pilferage. Current practices include using a bar code or QR reader to read the bar or QR codes on each box, or using a hand-held RFID device to scan RFID tags on boxes as they are loaded or unloaded. Other techniques include mounting RFID readers on the doors of loading docks and reading the RFID tags on the boxes as they pass through the dock doors during loading and unloading of the boxes. However, this is an expensive solution, since a large manufacturing facility may have hundreds of parts suppliers, each of which may have a large number of dock doors through which parts boxes may pass.

Matters are further complicated because of the practice of “cross-docking.” Cross-docking occurs when suppliers are shipping less than a full or full truckload of palletized boxes. Two or more such suppliers transport boxes to a terminal where the boxes are unloaded and the boxes from each supplier that are being transported to a single facility are consolidated, for example, by placing on shipping pallets. The boxes are placed into a single trailer that is then transported by, for example, a single tractor, to the manufacturing facility. Meanwhile, suppliers shipping full trailer loads can transport the parts boxes directly to the manufacturing facility. This practice saves time, fuel, and reduces delays.

Therefore, this application provides a solution that is simple and relatively easy to implement but that nevertheless efficiently tracks the location of large quantities of parts boxes as they travel in a closed loop between and among parts suppliers and manufacturers. While a preferred embodiment of the present invention will be described with regard to state of the art RFID readers and tags, the invention also contemplates that other wireless identification systems are being and will be developed that will be suitable for use with the invention described in this application. The invention is described with reference to a transportation system that relies on over-the-road transport by, for example, tractor trailer trucks. However, this invention has application to a wide range of transportation systems, including by rail, water, air or any combination of systems.

### SUMMARY OF THE INVENTION

It is therefore an object of the present invention to provide a closed-loop container, trailer identification and tracking method and apparatus.

It is another object of the invention to provide a method and apparatus of identifying and tracking the location of boxes as they travel to and from parts suppliers and users.

It is another object of the invention to provide a method and apparatus of identifying and tracking the location of boxes as they travel to and from cross-docking terminals for reloading and transport to users.

These and other objects and advantages of the invention are achieved by providing a closed-loop box identification and tracking method that includes the steps of providing an RFID tag on respective ones of a plurality of boxes for being moved between an origination point and a destination point, and providing at least one box transport apparatus for moving the boxes between the origination point and the destination point. At least one RFID reader/transmitter is provided on the at least one box transport apparatus that is adapted to read the RFID tag when in proximity to the RFID reader/transmitter and transmit the identification of the RFID tag. An RFID receiver is associated with a digital computer for receiving, storing and processing the transmitted RFID identification. The location of the boxes from the processed RFID identification is determined on a real time basis.

According to another embodiment of the invention, the origination point is a parts supplier and the destination point is a factory that utilizes the supplied parts in a manufacturing process.

According to another embodiment of the invention, the origination point is a transportation terminal and the destination point is a factory that utilizes parts shipped the boxes in a manufacturing process.

According to another embodiment of the invention, the origination point is a parts supplier; the destination point is a factory that utilizes parts shipped in the boxes in a manufacturing process, and including an intermediate point comprising a transportation terminal.

According to another embodiment of the invention, the method includes the steps of shipping boxes between and among a transportation terminal and a plurality of parts suppliers and parts users, wherein RFID readers/transmitters are provided at the transportation terminal and at each of the parts suppliers and parts users.

According to another embodiment of the invention, the method includes shipping two or more cargos of boxes first from parts suppliers to the transportation terminal, consolidating the two or more cargos of boxes into a single cargo of boxes and delivering the single cargo of boxes to a factory. An RFID reader is provided at a location where the two or more cargos of boxes are loaded onto a transport apparatus, at the consolidation terminal and at the factory, and the RFID tags on the boxes are read, stored and processed in the digital computer for determining the location of the boxes from the processed RFID identification.

According to another embodiment of the invention, a closed-loop box identification and tracking system is provided that includes a plurality of boxes for being moved by at least one box transport apparatus between an origination point and a destination point. Each box contains an RFID tag, and at least one RFID reader/transmitter is provided to interact with the at least one box transport apparatus, and is adapted to read the RFID tags when in proximity to the RFID reader/transmitter and transmit the identification of the RFID tag. An RFID receiver and associated digital computer is provided for receiving, storing and processing the transmitted RFID identification and for determining the location of the boxes from the processed RFID identification.

According to another embodiment of the invention, the RFID reader/transmitter is mounted on the at least one box transport apparatus in a position to read the RFID tags as the boxes are being loaded onto and off of the box transport apparatus.

According to another embodiment of the invention, the system includes RFID readers/transmitters provided at an origination point and at a destination point.

According to another embodiment of the invention, the system includes RFID readers/transmitters provided at the origination point, at the destination point, and at a transportation terminal between the origination point and the destination point.

According to another embodiment of the invention, the origination point is a parts supplier and the destination point is a factory that utilizes parts shipped in the boxes in a manufacturing process.

According to another embodiment of the invention, an RFID reader/transmitter is provided at the origination point where two or more cargos of boxes are loaded onto the box transport apparatus, at a consolidation terminal and at a factory, and the RFID tags on the boxes are read, stored and processed in the digital computer for determining the location of the boxes from the processed RFID identification,

According to another embodiment of the invention, the transport apparatus is selected from the group consisting of over the road trucks, tractor/trailers, railway trains and aircraft.

According to another embodiment of the invention, the boxes each have two separable parts, each of which have a separate RFID tag.

According to another embodiment of the invention, the two separable parts are a box body and a box lid.

### BRIEF DESCRIPTION OF THE DRAWING FIGURES

The present invention is best understood when the following detailed description of the invention is read with reference to the accompanying drawings, in which:

FIG. 1 is a schematic view of a closed-loop container identification and tracking method according to an embodiment of the invention;

FIG. 2 is a schematic view of a method of shipping boxes among parts suppliers, a manufacturing facility and a shipping terminal utilizing cross-docking according to an embodiment of the invention; and

FIG. 3 is a schematic view illustrating wireless identification of parts boxes as they are loaded onto and loaded off of a shipping container, such as a truck trailer.

### DETAILED DESCRIPTION OF THE PREFERRED EMBODIMENT

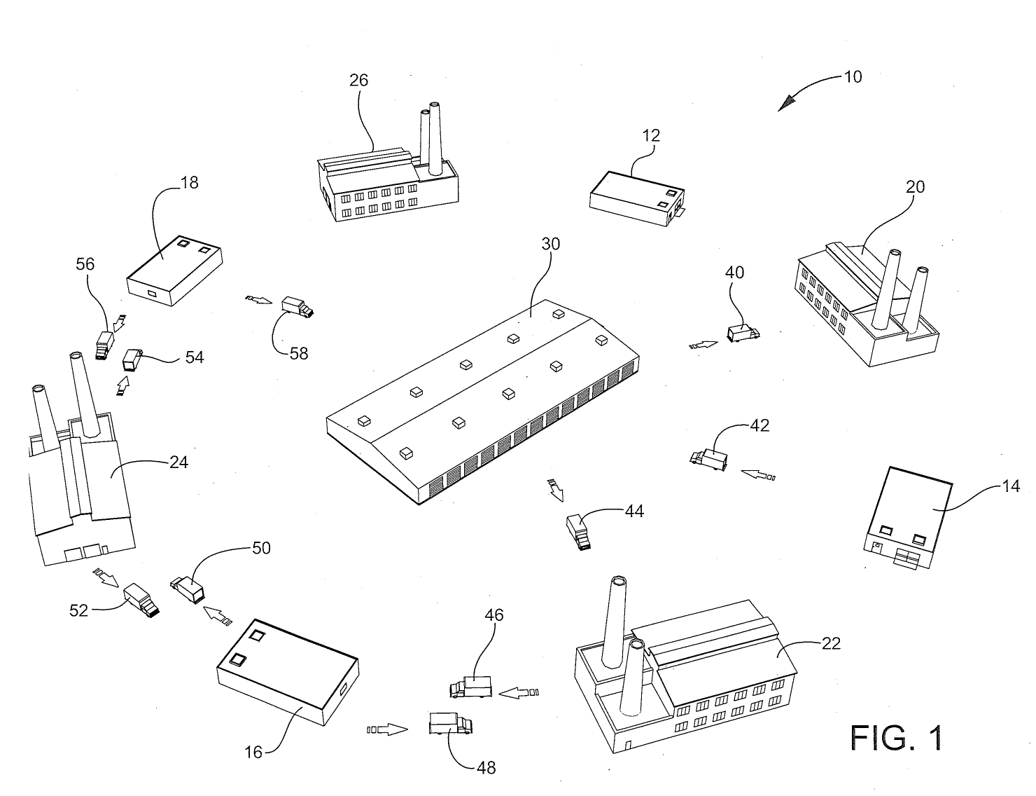

Referring now to the drawings, a hypothetical example of a transportation environment is illustrated schematically at reference numeral 10 of FIG. 1. Parts suppliers 12, 14, 16 and 18 supply parts to manufacturing facilities 20, 22, 24 and 26. A transportation terminal 30 facilitates shipment of cargo between and among the parts suppliers 12, 14, 16 and 18 and manufacturing facilities 20, 22, 24 and 26. Tractor trailer trucks 40, 42, 44, 46, 48, 50, 52, 54, 56 and 58 transport the boxes as shown. For example, shipment of full loads of cargo from supplier 16 travel directly to and from factory 22. As described above, shipments of cargo representing less than a full trailer load and/or a full trailer load travel first from the suppliers to the consolidation terminal 30, for example, trucks 42 and 58 transporting cargo from suppliers 14 and 18 to terminal 30.

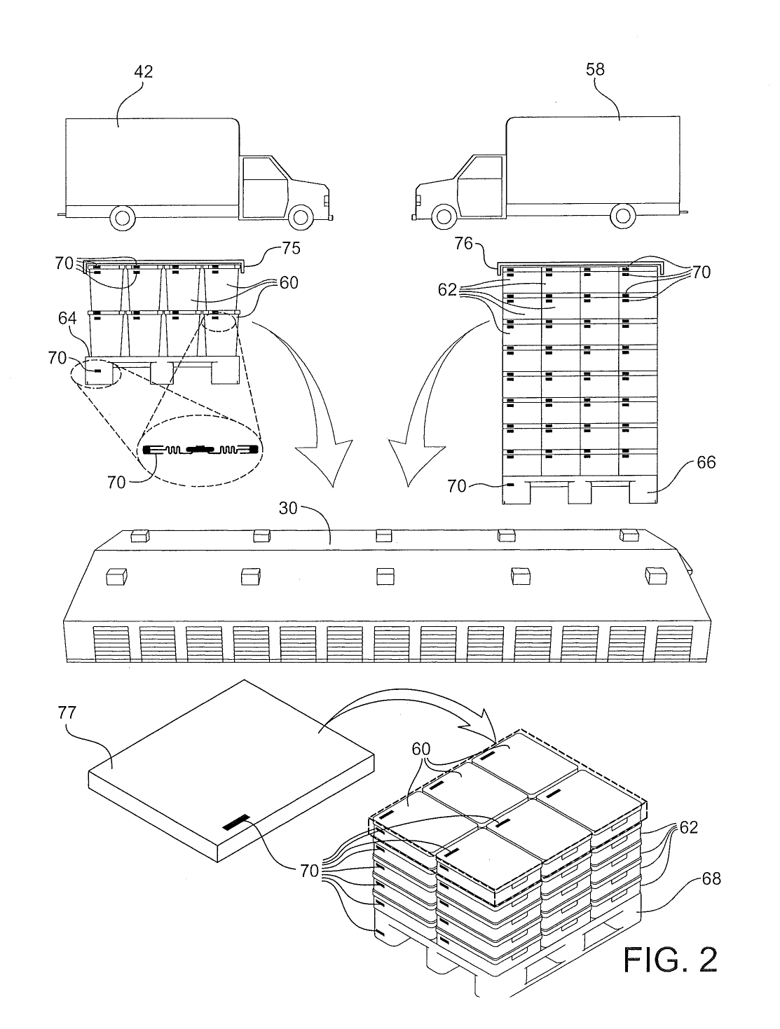

Referring to FIG. 2, trucks 42 and 58 arrive at the terminal 30 with less than full loads of cargo-containing boxes 60 and 62, respectively. Note also that the boxes 60 and 62 are represented as being different sizes, and are positioned on shipping pallets 64 and 66, respectively. The boxes 60 and 62 are consolidated onto a single pallet 68, as shown, and are ready to be loaded back onto a truck, for example truck 44, and shipped to factory 22. As also shown, each box 60 and 62, including lids, includes an RFID tag 70, as do also each pallet 64, 66 and 68, and each top cap 75, 76 and 77.

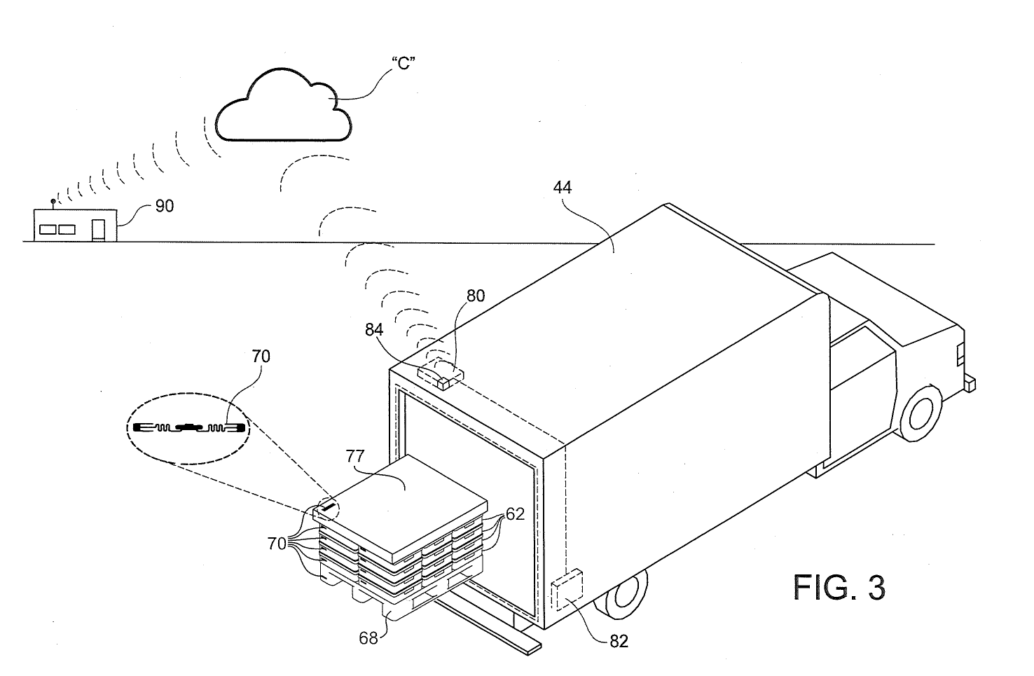

Referring now to FIG. 3, truck 44 is shown being loaded and unloaded. As described above, boxes 60, including the top caps, each have RFID tags 70. The rear opening of the truck trailer is provided with an RFID reader/transmitter 80. The RFID reader/transmitter 80 includes a junction box 82 that takes electric current from the truck's power supply, and an antenna 84 that extends around the trailer opening. As boxes 60 are loaded onto the truck 44, the antenna 84 of the RFID reader/transmitter 80 detects the proximity of the RFID tags 70 as they move into the trailer and past the antenna 84. The unique signal from each RFID tag 70 is detected and transmitted wirelessly to a computer 90 programmed to store the received information and process the information as needed to allow data access in a manner that allows the location of the RFID tag 70 to be determined. Similarly, as boxes 60 are unloaded the truck 44, the antenna 84 of the RFID reader/transmitter 80 detects the proximity of the RFID tags 70 as they move out of the trailer and past the antenna 84. The unique signal from each RFID tag 70 is detected and transmitted wirelessly to the computer 90 programmed to store the received information and process the information as needed to allow data access in a manner that allows the location of the RFID tag 70 to be determined. As shown in FIG. 3, the wireless signals may be transmitted to a “cloud” storage device “C” where it can be retrieved by the computer 90 either in real time or at some later time. Alternatively, a handheld RFID reader can be used by a worker standing near the boxes 60 as they are loaded or unloaded.

By reference back to FIGS. 2 and 3, it will be understood that at every intersection between the trucks, the suppliers and factories the location of the boxes 60 can be determined and the computer 90 updated with the current location of each box 60. This occurs without the necessity of placing RFID readers/transmitters at the loading docks of the supplier, terminal and factory facilities.

The RFID tags 70 are preferably passive, meaning that each tag 70 relies on RF energy transferred from the reader/transmitter 80 to the tag to power the tag 70. While not preferred, other RFID systems, and optical systems such as use bar or QR codes may be used in particular applications. Of course, in given applications boxes 60 may move only between suppliers and factories without an intermediate cross-docking transit and still be within the scope of the invention.

A closed-loop container identification and tracking method and apparatus according to the invention have been described with reference to specific embodiments and examples. Various details of the invention may be changed without departing from the scope of the invention. Furthermore, the foregoing description of the preferred embodiments of the invention and best mode for practicing the invention are provided for the purpose of illustration only and not for the purpose of limitation, the invention being defined by the claims.

I/we claim:

1. A closed-loop box identification and tracking method that includes the steps of:
(a) providing an RFID tag on respective ones of a plurality of boxes for being moved between an origination point and a destination point;
(b) providing at least one box transport apparatus for moving the boxes between the origination point and the destination point;
(c) providing an RFID reader/transmitter on the at least one box transport apparatus adapted to read the RFID tag when in proximity to the RFID reader/transmitter and transmit the identification of the RFID tag;
(d) providing a RFID receiver associated digital computer for receiving, storing and processing the transmitted RFID identification; and
(e) determining the location of the boxes from the processed RFID identification.

2. A method according to claim 1, wherein the origination point is a parts supplier and the destination point is a factory that utilizes the supplied parts in a manufacturing process.

3. A method according to claim 1, wherein the origination point is a transportation terminal and the destination point is a factory that utilizes parts shipped the boxes in a manufacturing process.

4. A method according to claim 1, wherein the origination point is a parts supplier, the destination point is a factory that utilizes parts shipped in the boxes in a manufacturing process, and including an intermediate point comprising a transportation terminal.

5. A method according to claim 1, and including the steps of shipping boxes between and among a transportation terminal and a plurality of parts suppliers and parts users, wherein RFID readers/transmitters are provided at the transportation terminal and at each of the parts suppliers and parts users.

6. A method according to claim 5, wherein the method includes shipping two or more cargos of boxes first from parts suppliers to the transportation terminal, consolidating the two or more cargos of boxes into a single cargo of boxes and delivering the single cargo of boxes to a factory, wherein an RFID reader is provided at a location where the two or more cargos of boxes are loaded onto a transport apparatus, at the consolidation terminal and at the factory, and the RFID tags on the boxes are read, stored and processed in the digital computer for determining the location of the boxes from the processed RFID identification.

7. A closed-loop box identification and tracking system, comprising:
(a) a plurality of boxes for being moved by at least one box transport apparatus between an origination point and a destination point, each box containing an RFID tag;
(b) at least one RFID reader/transmitter provided to interact with the at least one box transport apparatus, and adapted to read the RFID tags when in proximity to the RFID reader/transmitter and transmit the identification of the RFID tag; and
(c) an RFID receiver and associated digital computer for receiving, storing and processing the transmitted RFID identification for determining the location of the boxes from the processed RFID identification.

8. A system according to claim 7, wherein the RFID reader/transmitter is mounted on the at least one box transport apparatus in a position to read the RFID tags as the boxes are being loaded onto and off of the box transport apparatus.

9. A system according to claim 7, wherein the system includes RFID readers/transmitters provided at an origination point and at a destination point.

10. A system according to claim 7, wherein the system includes RFID readers/transmitters provided at the origination point, at the destination point, and at a transportation terminal between the origination point and the destination point.

11. A system according to claim 10, wherein the origination point is a parts supplier and the destination point is a factory that utilizes parts shipped in the boxes in a manufacturing process.

12. A system according to claim 11, and including an RFID reader/transmitter provided at the origination point where two or more cargos of boxes are loaded onto the box transport apparatus, at a consolidation terminal and at a factory, and the RFID tags on the boxes are read, stored and processed in the digital computer for determining the location of the boxes from the processed RFID identification.

13. A system according to claim 12, wherein the transport apparatus is selected from the group consisting of over the road trucks, tractor/trailers, railway trains and aircraft.

14. A system according to claim 7, wherein the boxes each have two separable parts, each of which have a separate RFID tag.

15. A system according to claim 14, wherein the two separable parts are a box body and a box lid.
